(19) United States
(12) Patent Application Publication
(10) Pub. No.: US 2025/0310396 A1
(43) Pub. Date: Oct. 2, 2025

(54) Method, System and Computer Program Product for Joint Control of a Plurality of Devices

(71) Applicant: Andreas Stihl AG & Co. KG, Waiblingen (DE)

(72) Inventors: Jens MAHLER, Fellbach (DE); Shiraz TUMASYAN, Muenchen (DE)

(21) Appl. No.: 19/091,154

(22) Filed: Mar. 26, 2025

(30) Foreign Application Priority Data
Mar. 27, 2024 (DE) 10 2024 108 833.8

(51) Int. Cl. H04L 67/025

(52) U.S. Cl. CPC H04L 67/025

(57) ABSTRACT

A method jointly controls a plurality of devices, a plurality of mobile devices in particular, selected from a set including at least one piece of work equipment, at least one rechargeable battery pack for the piece of work equipment or at least one charger for the rechargeable battery pack. The method: a) acquires at least one first user input selecting the plurality of devices, in particular from the set of output devices, b) outputs at least one executable joint assignment determined on the basis of the acquired at least one first user input such that it is jointly executable for the selected plurality of devices, c) acquires a second user input, exactly one second user input in particular, determining at least one joint assignment, exactly one joint assignment in particular, from the output at least one executable joint assignment, and d) transmits the joint assignment determined on the basis of the acquired second user input or transmitting a parameter corresponding to the joint assignment, in each case to the selected plurality of devices.

### CROSS REFERENCE TO RELATED APPLICATION

This application claims priority under 35 U.S.C. § 119 from German Patent Application No. 10 2024 108 833.8, filed Mar. 27, 2024, the entire disclosure of which is herein expressly incorporated by reference.

### BACKGROUND AND SUMMARY

The invention relates to a method, a system and a computer program product for joint control of a plurality of devices, with each of the method, system and computer program product providing joint control of a plurality of devices in particular.

The problem addressed by the invention is that of providing a method, a system and a computer program product for joint control of a plurality of devices, with each of the method, system and computer program product providing joint control of a plurality of devices in particular, the provided method, system and/or computer program product having improved properties.

The invention solves this problem by the provision of a method, a system and a computer program product as described in the independent claims. Advantageous developments and/or configurations of the invention are described in the dependent claims.

The method according to the invention serves for joint control of a plurality of devices, a plurality of mobile devices in particular. The devices are selected from a set or a list or a fleet comprising at least one piece of work equipment, at least one rechargeable battery pack for the piece of work equipment or at least one charger for the rechargeable battery pack. In other words: The devices comprise at least the piece of work equipment, at least the rechargeable battery pack and/or at least the charger. The method includes the steps of:
a) acquiring at least one first user input, in particular input by a user, selecting the plurality of devices, in particular from the set of output devices.
b) outputting at least one executable joint assignment, in particular information about the executable joint assignment and/or to the user. The assignment is determined on the basis of the acquired at least one first user input such that it is jointly executable for the selected plurality of devices.
c) acquiring a second user input, exactly one second user input in particular, in particular input by the user, determining at least one joint assignment, exactly one joint assignment in particular, from the output at least one executable joint assignment.
d) transmitting the joint assignment determined on the basis of the acquired second user input or transmitting a parameter corresponding to the joint assignment, in each case to the selected plurality of devices, exactly to the selected plurality of devices in particular.

This—in particular that the assignment is jointly executable for the selected plurality of devices—allows the joint control of the selected plurality of devices to be simple and/or user friendly, the user-friendliness being a result thereof in particular, in particular by means of the joint acquisition, and in particular not an individual acquisition, of the second user input for the selected plurality of devices.

In addition to that or in an alternative, this in particular renders possible that the assignment is jointly executable for the selected plurality of devices, that no non-executable joint assignment or no parameter corresponding thereto can be transmitted to the selected plurality of devices and/or step d) cannot be executed.

In a further addition to that or in a further alternative, this renders possible the avoidance of an unnecessary transmission, the avoidance being a result thereof in particular, in particular to non-selected devices.

In particular, the method, the control, the acquisition, the output and/or the transmission may be automated and/or computer implemented.

The term “administer” or “manage” or “operate” may be used synonymously with the term “control”.

The term “comprising/comprise” or “having/have” may be used synonymously with the term “including/include”.

The term “portable” may be used synonymously with the term “mobile”.

The mobile device may have a mass of no more than 50 kg (kilograms), in particular no more than 20 kg, in particular no more than 10 kg, in particular no more than 5 kg, and/or at least 0.2 kg, in particular at least 0.5 kg, in particular at least 1 kg, in particular at least 2 kg.

The devices may be at least two pieces of work equipment, at least one piece of work equipment and at least one rechargeable battery pack or at least one charger, at least two rechargeable battery packs, at least one rechargeable battery pack and at least one charger, and/or at least two chargers. In other words: Any desired combination of pieces of work equipment and/or rechargeable battery packs and/or chargers may be provided.

The piece of work equipment may be motor driven and/or electrically driven, in particular by operating energy or drive power or discharging power from the rechargeable battery pack.

The piece of work equipment and the rechargeable battery pack may be designed to be connected to one another electrically and, in particular, mechanically and/or in tool-free fashion and/or user-detachably, non-destructively user-detachably in particular; in particular they may comprise the connection.

The rechargeable battery pack may be designed to supply the piece of work equipment with operating energy, electrical operating energy in particular, in particular in the event of the connection, and/or to be rechargeable, in particular using operating energy or charging power from the charger.

The rechargeable battery pack and the charger may be designed to be connected to one another electrically and, in particular, mechanically and/or in tool-free fashion and/or user-detachably, non-destructively user-detachably in particular; in particular, they may comprise the connection.

The charger may be designed to supply the rechargeable battery pack with operating energy, electrical operating energy in particular, in particular in the event of the connection.

The term “battery pack” may be used synonymously with the term “rechargeable battery pack”.

The devices may be user selectable.

The first user input, the executable joint assignment, the second user input, the determined joint assignment, or the parameter corresponding thereto may contain a value and/or a content, with each of the first user input, the executable joint assignment, the second user input, the determined joint assignment, or the parameter corresponding thereto possibly containing a value and/or a content in particular.

The term “device user input” may be used synonymously with the phrase “first user input”.

The term “selecting/selected” may be used synonymously with the term “choosing/chosen”.

The term “supported”, “possible”, “available” or “processable” may be used synonymously with the term “executable”.

The information may be user perceivable.

The at least one executable joint assignment may be user determinable.

The term “assignment user input” may be used synonymously with the phrase “second user input”.

Step d) may include a reception by means of the selected plurality of devices of the transmitted joint assignment or the transmitted parameter corresponding thereto.

The transmission and/or the reception, each of the transmission and/or the reception in particular, may be wireless or cableless.

The phrase “based on” may be used synonymously with the phrase “corresponding thereto”.

Temporally before step a), the method may include the step of: outputting the set.

Step a) may be executed repeatedly, in particular with multiple repetitions, and/or by means of an acquisition apparatus.

Step b) may be executed temporally after step a) and/or by means of an output apparatus.

Step c) may be executed temporally after step b), at the same time as and temporally after step b) in particular, and/or by means of the acquisition apparatus.

Step d) may be executed temporally after step c) and/or by means of a transmission apparatus, and in particular by means of a reception apparatus of the device.

The method may be executed repeatedly, in particular with multiple repetitions.

The component of the term “unit” may be used synonymously with the component of the term “apparatus”.

The term “happen” or the phrase “be performed” or “be implemented” may be used synonymously with the phrase “be executed”.

Should no assignment be jointly executable for the selected plurality of devices and/or, in particular as a result thereof, should no assignment be determinable on the basis of the acquired at least one first user input, it is not possible to output an assignment, and/or step b) cannot be executed and in particular step c) and step d) cannot be executed.

The one assignment may be determined on the basis of the one acquired at least one first user input, in such a way that the assignment is jointly executable for the one selected plurality of devices, and may be output. Another assignment may be determined on the basis of another acquired at least one first user input, in such a way that the other assignment is jointly executable for another selected plurality of devices, and may be output.

At least one non-executable joint assignment may be output, in particular in such a way that a distinction can be made between the executable joint assignment and the non-executable joint assignment, in particular by the user, e.g. by means of a prioritization.

Furthermore, reference is made to the technical literature.

An alternative method, which might be an independent invention and/or on the basis of which a divisional application might be filed, for controlling at least one device of the devices may include the steps of:
a) acquiring at least one user input, a first user input in particular, determining at least one assignment, in particular from a set of output assignments.
b) acquiring at least one user input, a second user input in particular, selecting at least the device for which the determined at least one assignment should be executed, in particular temporally after step a).

In particular, temporally after step a) and before step b), the method may include the step of: outputting at least the device, in particular information about the device. The device is determined on the basis of the acquired at least one first user input such that the determined at least one assignment is executable for it.

In addition to that or in an alternative, temporally after step b), the method may include the step of: transmitting the assignment determined on the basis of the acquired first user input or transmitting a parameter corresponding to the assignment, in each case to the device selected on the basis of the acquired second user output.

This—in particular that the assignment is executable for the device—renders possible that no non-executable assignment or no parameter corresponding thereto can be transmitted to the selected device and/or the transmission cannot be executed. This renders possible the avoidance of an unnecessary transmission.

In a development of the invention, temporally after step a) and temporally before step b), the method includes the step of: determining the executable joint assignment on the basis of the acquired first user input, in particular by means of at least one portion of a buffer storage. In particular, the determination may be automated and/or computer implemented. In addition to that or in an alternative, the portion of the buffer storage may be a terminal portion. In a further addition to that or in a further alternative, the buffer storage may differ from the devices, the selected plurality of devices in particular, or be separate therefrom and/or be electrical.

In a development of the invention, the selected plurality of devices each comprise at least one assignment executable for them. The executable joint assignment is determined as an intersection of the at least one executable assignment. This allows the assignment to be jointly executable for the selected plurality of devices. In particular, the devices may each be assigned, logically assigned in particular, or related to, the at least one assignment executable for them, the assignment being stored or saved in the portion of the buffer storage in particular.

In a development of the invention, the devices or the set comprise(s) different pieces of work equipment. In particular, the piece of work equipment is a piece of user-controlled work equipment or an autonomous mobile work robot. For such work equipment, the method is particularly advantageous and/or the executable joint assignment is type specific. In particular, the piece of work equipment may be a piece of garden, forestry, construction and/or soil work equipment, in particular a saw, a pole pruner, a hedge trimmer, a hedge cutter, a wood cutter, pruning shears, a blower, a leaf blower, a suction device, a leaf vacuum, a cleaning device, a pressure washer, a spraying device, a sweeper, a sweeping roller, a sweeping brush, a lawnmower, grass shears, a scarifier, a brush cutter, an angle grinder, a stone cutter or a combination tool made of a plurality of the aforementioned types of work equipment. In particular, the piece of work equipment may be a chainsaw or a robotic lawnmower. In addition to that or in an alternative, the piece of work equipment may be guided on the ground and/or by hand, in particular handheld. In a further addition to that or in a further alternative, the phrase “manually or operable or controllable by the user” can be used synonymously with the term “user controlled”. Furthermore, reference is made to the technical literature.

In a development of the invention, the executable joint assignment comprises a modifiable setting, a modifiable grouping or a command, a modifiable command in particular. In particular, the second user input determines a modification or a confirmation of the setting, a modification, a creation or a confirmation of the grouping or an execution or a modification of the command. The method is particularly advantageous for such an assignment, and/or such an assignment is particularly advantageous for the devices, the plurality of selected devices in particular. In particular, step b) and step c) may be executed temporally after step b), in such a way that with the second user input, exactly with the second user input in particular, in particular at once and/or immediately or directly, the output modification or the output confirmation of the setting, the output modification, the output creation or the output confirmation of the grouping or the output execution or the output modification of the command may be determined. In addition to that or in an alternative, step b) and step c) may be executed at the same time as and temporally after step b), in such a way that with at least the second user input, in particular firstly, the output setting, the output grouping or the output command may be determined and, in particular secondly, the modification or the confirmation output on the basis of the determination of the setting, the modification, the creation or the confirmation output on the basis of the determination of the grouping or the execution or the modification output on the basis of the determination of the command may be determined.

In a configuration of the invention, temporally after step c) including the acquisition of the second user input determining the joint assignment comprising the setting or the grouping and temporally before step d), the method includes the step of: acquiring a user input, exactly one user input in particular, for initiation, in particular input by the user. Step d) including the transmission of the determined joint assignment comprising the setting or the grouping or the parameter corresponding thereto is executed initiated by the acquisition of the user input for initiation, exactly initiated thereby in particular. In addition to that or in an alternative, step d) including the transmission of the determined joint assignment comprising the command or the parameter corresponding thereto is executed initiated by the acquisition of the second user input determining the joint assignment comprising the command, exactly initiated thereby in particular. This enables user friendliness. In particular, the acquisition may be automated and/or computer implemented and/or may be executed by means of the acquisition apparatus. In addition to that or in an alternative, the phrase “third user input” or “initiation user input” may be used synonymously with the phrase “user input for initiation”.

In particular, the method may be such that the transmitted joint assignment comprising the setting or the grouping or the transmitted parameter corresponding thereto is adopted by the device, in particular at once and/or immediately or directly, in the event of an operation thereof.

In a configuration of the invention, the method is such that the transmitted joint assignment comprising the setting or the grouping or the transmitted parameter corresponding thereto is adopted by the device in the event of a non-operation thereof, and in particular is not adopted during an operation of the device. This allows a current or present operation of the device to be fully executed or finished with a previous setting or with a previous grouping. In particular, the transmitted joint assignment comprising the setting or the grouping or the transmitted parameter corresponding thereto may be adopted, in particular only adopted, by the device for a temporally successive or next operation thereof.

In particular, the method may be such that the transmitted joint assignment comprising the command or the transmitted parameter corresponding thereto is adopted by the device, in particular at once and/or immediately or directly, in the event of an operation thereof.

In a development of the invention, temporally after step d), the method includes the step of: outputting information about a status regarding an adoption by the device of the transmitted joint assignment or of the transmitted parameter corresponding thereto, in particular wherein the status is adoption executed, adoption failed or adoption pending. This enables feedback, in particular for the user. In particular, the output may be automated and/or computer implemented and/or may be executed by means of the output apparatus. In addition to that or in an alternative, the information may comprise a value and/or a content and/or may be user perceivable. In a further addition to that or in a further alternative, the term “state” may be used synonymously with the term “status”.

In a development of the invention, the acquisition of the first user input, of the second user input and/or of the user input for initiation comprises a haptic acquisition and/or is executed by means of a terminal, a mobile terminal in particular. In addition to that or in an alternative, the output of the possible joint assignment and/or of the information comprises an optical output and/or is executed by means of the terminal. This allows the joint control of the selected plurality of devices to be particularly simple and/or particularly user friendly, the particular user-friendliness being a result thereof in particular. In particular, the terminal may be different or separate from the devices, the selected plurality of devices in particular, and/or the buffer storage and/or may be electrical and/or may be a user terminal, such as e.g. a smartphone, a tablet computer or a desktop computer. In addition to that or in an alternative, the terminal may comprise the acquisition apparatus, such as e.g. a mouse, a keyboard or a touchscreen, the output apparatus, such as e.g. a display device, a monitor or the touchscreen, and/or the transmission apparatus. In a further addition to that or in a further alternative, the optical output may comprise displaying, in particular be displaying. Furthermore, reference is made to the technical literature.

In a development of the invention, step d) includes: transmitting the determined joint assignment or the parameter corresponding thereto from a terminal, the terminal in particular, to a buffer storage, the buffer storage in particular. transmitting the determined joint assignment, the parameter corresponding thereto or a parameter corresponding thereto from the buffer storage to the selected plurality of devices. Independently of allowing an immediate or direct communication option from the terminal to the devices, the selected plurality of devices in particular, this allows robustness, in particular vis-à-vis latency and/or brief non-availability of at least one single component. In particular, the determined joint assignment, the parameter corresponding thereto or the parameters corresponding thereto may be buffer stored, in particular become buffer stored, in the buffer storage. In addition to that or in an alternative, the buffer storage may be at least one gateway, at least one router and/or at least one cloud backend. In a further addition to that or in a further alternative, the terminal, the buffer storage and the devices, the selected plurality of devices in particular, may be a networked infrastructure. In a further addition to that or in a further alternative, the transmission from the buffer storage to the selected plurality of devices may be by way of messages, which might be part of a publish-subscribe communication in particular. In a further addition to that or in a further alternative, the transmission may be automated and/or computer implemented. In a further addition to that or in a further alternative, step d) may include a reception by means of the buffer storage of the transmitted joint assignment or the transmitted parameter corresponding thereto. In a further addition to that or in a further alternative, step d) may include a reception by means of the selected plurality of devices of the transmitted joint assignment, the transmitted parameter corresponding thereto or the transmitted parameters corresponding thereto. In a further addition to that or in a further alternative, the transmission and/or the reception, each of the transmission and/or the reception in particular, may be wireless or cableless. In a further addition to that or in a further alternative, step d) may be executed by means of the transmission apparatus of the terminal, a reception apparatus of the buffer storage, a transmission apparatus of the buffer storage and/or the reception apparatus of the device. Furthermore, reference is made to the technical literature.

In a configuration of the invention, the buffer storage comprises a terminal portion, the terminal portion in particular, and a device portion. A communication of the determined joint assignment or the parameter corresponding thereto from the terminal to the terminal portion comprises a synchronous communication; in particular, it is the synchronous communication. A communication of the determined joint assignment, the parameter corresponding thereto or a parameter corresponding thereto, the parameter corresponding thereto in particular, from the terminal portion to the device portion for the transmission to the selected plurality of devices comprises an asynchronous communication; in particular, it is the asynchronous communication. This enables an improvement in the performance, in particular by way of the separation of the components and/or the independent communication option between the components (for instance, one component need not wait for another component and is blocked as a result). In particular, the communication, each communication in particular, may be automated, computer implemented and/or wireless or cableless. In addition to that or in an alternative, the term “transmission” may be used synonymously with the term “communication”. In a further addition to that or in an alternative, the terminal may be an app frontend, the terminal portion may be an app backend and/or the device portion may be a device backend. In a further addition to that or in a further alternative, the synchronous communication may be API-to-API communication. In a further addition to that or in a further alternative, the asynchronous communication may be a publish-subscribe communication. Furthermore, reference is made to the technical literature.

In a development of the invention, temporally after step d), the method includes the step of: operating the selected plurality of devices, exactly the selected plurality of devices in particular, in each case using the transmitted joint assignment or the transmitted parameter corresponding thereto, following the adoption of the assignment or the parameter. In particular, the operation may be automated, computer implemented and/or joint.

The system according to the invention is designed for the joint control of the plurality of devices selected from the set comprising at least the piece of work equipment, at least the rechargeable battery pack for the piece of work equipment or at least the charger for the rechargeable battery pack. The system comprises the acquisition apparatus, the output apparatus and the transmission apparatus, and in particular at least the plurality of devices. The acquisition apparatus is designed to acquire the at least one first user input selecting the plurality of devices. The output apparatus is designed to output the at least one executable joint assignment, determined on the basis of the acquired at least one first user input such that it is jointly executable for the selected plurality of devices. The acquisition apparatus is designed to acquire the second user input determining at least the joint assignment from the output at least one executable joint assignment. The transmission apparatus is designed to transmit the joint assignment determined on the basis of the acquired second user input or transmit the parameter corresponding to the joint assignment, in each case to the selected plurality of devices. In particular, the system is designed, in particular an operating apparatus of the system is designed and/or at least the selected plurality of devices are designed, to operate the selected plurality of devices, in each case using the transmitted joint assignment or the transmitted parameter corresponding thereto, following adoption of the assignment or the parameter. The system may enable the same advantage(s) as mentioned above for the method. In particular, the system may be designed to execute, automatically execute in particular, the method as specified above. In addition to that or in an alternative, the term “configured”, “set up” or “provided” or the phrase “programmed to perform the function(s) of” may be used synonymously with the term “designed”. In a further addition to that or in a further alternative, the system, the acquisition apparatus, the output apparatus and/or the transmission apparatus may be electrical. In a further addition to that or in a further alternative, the system may comprise the buffer storage. In a further addition to that or in a further alternative, the system, the buffer storage and/or the operating apparatus may comprise a computing apparatus and/or a processor and/or a microcontroller and/or a storage apparatus and/or a computer.

The computer program product according to the invention comprises commands for the joint control of the plurality of devices selected from the set comprising at least the piece of work equipment, at least the rechargeable battery pack for the piece of work equipment or at least the charger for the rechargeable battery pack. The commands comprise: during execution, in particular by means of the acquisition apparatus, the acquisition of the at least one first user input selecting the plurality of devices. during execution, in particular by means of the output apparatus, the output of the at least one executable joint assignment, determined on the basis of the acquired at least one first user input such that it is jointly executable for the selected plurality of devices. during execution, in particular by means of the acquisition apparatus, the acquisition of the second user input determining at least the joint assignment from the output at least one executable joint assignment. during execution, in particular by means of the transmission apparatus, the transmission of the joint assignment determined on the basis of the acquired second user input or the transmission of the parameter corresponding to the joint assignment, in each case to the selected plurality of devices. in particular during execution, in particular by means of the system, the operation of the selected plurality of devices, in each case using the transmitted joint assignment or the transmitted parameter corresponding thereto, following the adoption of the assignment or the parameter. The computer program product may enable the same advantage(s) as mentioned above for the method. In particular, the computer program product may be made for execution, automatic execution in particular, of the method as mentioned above and/or by means of the system as mentioned above. In addition to that or in an alternative, the computer program product may be stored on a computer-readable (storage) medium. In a further addition to that or in a further alternative, the commands may describe the method.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic view of a system according to an embodiment of the invention when executing a method of a computer program product according to the embodiment;

FIG. 2 is a further schematic view of a portion of the method; and

FIG. 3 is yet a further schematic view of a portion of the method.

### DETAILED DESCRIPTION OF THE DRAWINGS

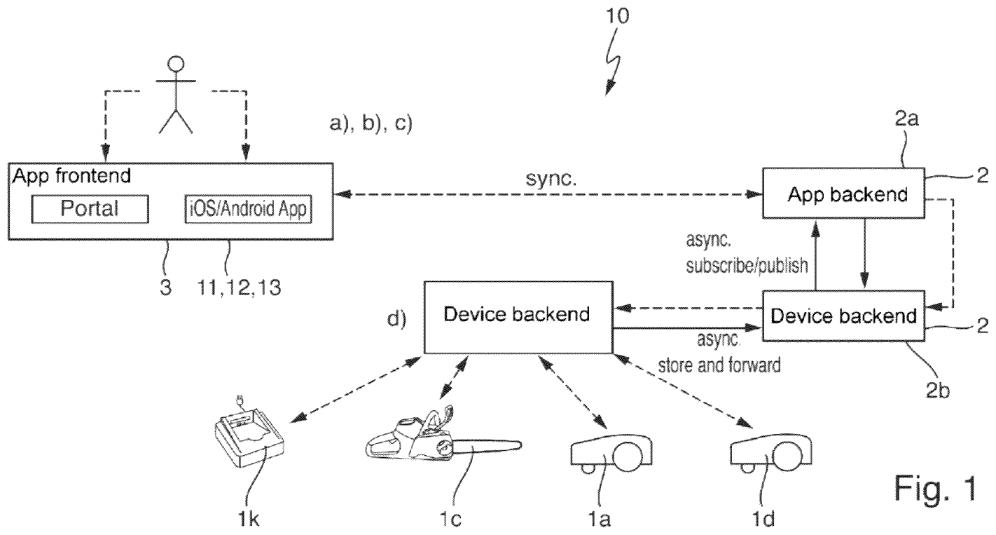

FIGS. 1 to 3 show a method of a computer program product and a system 10 for joint control of a plurality of devices 1a, 1d, 1f, 1h, a plurality of mobile devices in particular. The devices 1a, 1d, 1f, 1h are selected from a set comprising at least one piece of work equipment 1a, 1c, 1d, 1e, 1f, 1g, 1h, 1i, 1j, at least one rechargeable battery pack 1b for the piece of work equipment 1c, 1e, 1g, 1i or at least one charger 1k for the rechargeable battery pack 1b.

The method includes the steps of:
a) acquiring at least one first user input VBa, VBd, VBf, VBh selecting the plurality of devices 1a, 1d, 1f, 1h, in particular from the set of output devices 1a, 1b, 1c, 1d, le, 1f, 1g, 1h, 1i, 1j.
b) outputting at least one executable joint assignment gZa, gZb, gZc, gZd. The assignment gZa, gZb, gZc, gZd is determined on the basis of the acquired at least one first user input VBa, VBd, VBf, VBh such that it is jointly executable for the selected plurality of devices 1a, 1d, 1f, 1h.
c) acquiring a second user input ZBb, ZBc, ZBd, exactly one second user input in particular, determining at least one joint assignment gZb, gZc, gZd, exactly one joint assignment in particular, from the output at least one executable joint assignment gZa, gZb, gZc, gZd.
d) transmitting the joint assignment gZb, gZc, gZd determined on the basis of the acquired second user input ZBb, ZBc, ZBd or transmitting a parameter corresponding to the joint assignment, in each case to the selected plurality of devices 1a, 1d, 1f, 1h.

In detail, temporally after step d), the method includes the step of: operating the selected plurality of devices 1a, 1d, 1f, 1h in each case using the transmitted joint assignment gZb, gZc, gZd or the transmitted parameter corresponding thereto following adoption of the assignment gZb, gZc, gZd or the parameter.

The system 10 comprises an acquisition apparatus 11, an output apparatus 12 and a transmission apparatus 13, and in particular at least the plurality of devices 1a, 1d, 1f, 1h. The acquisition apparatus 11 is designed to acquire, in particular acquires, the at least one first user input VBa, VBd, VBf, VBh selecting the plurality of devices 1a, 1d, 1f, 1h. The output apparatus 12 is designed to output, in particular outputs, the at least one executable joint assignment gZa, gZb, gZc, gZd determined on the basis of the acquired at least one first user input VBa, VBd, VBf, VBh such that it is jointly executable for the selected plurality of devices 1a, 1d, 1f, 1h. The acquisition apparatus 11 is designed to acquire, in particular acquires, the second user input ZBb, ZBc, ZBd determining at least the joint assignment gZb, gZc, gZd from the output at least one executable joint assignment gZa, gZb, gZc, gZd. The transmission apparatus 13 is designed to transmit, in particular transmits, the joint assignment gZb, gZc, gZd determined on the basis of the acquired second user input ZBb, ZBc, ZBd or the parameter corresponding to the joint assignment, in each case to the selected plurality of devices 1a, 1d, 1f, 1h. In particular, the system 10 is designed to operate, in particular operates, the selected plurality of devices 1a, 1d, 1f, 1h, in each case using the transmitted joint assignment gZb, gZc, gZd or the transmitted parameter corresponding thereto, following the adoption of the assignment gZb, gZc, gZd or the parameter.

The computer program product comprises commands for the joint control of the plurality of devices 1a, 1d, 1f, 1h selected from the set comprising at least the piece of work equipment 1a, 1c, 1d, 1e, 1f, 1g, 1h, 1i, 1j, at least the rechargeable battery pack 1b for the piece of work equipment 1c, 1e, 1g, 1i or at least the charger 1k for the rechargeable battery pack 1b. The commands comprise: during execution, in particular by means of the acquisition apparatus 11, the acquisition of the at least one first user input VBa, VBd, VBf, VBh selecting the plurality of devices 1a, 1d, lf, 1h. during execution, in particular by means of the output apparatus 12, the output of the at least one executable joint assignment gZa, gZb, gZc, gZd determined on the basis of the acquired at least one first user input VBa, VBd, VBf, VBh such that it is jointly executable for the selected plurality of devices 1a, 1d, 1f, 1h. during execution, in particular by means of the acquisition apparatus 11, the acquisition of the second user input ZBb, ZBc, ZBd determining at least the joint assignment gZb, gZc, gZd from the output at least one executable joint assignment gZa, gZb, gZc, gZd. during execution, in particular by means of the transmission apparatus 13, the transmission of the joint assignment gZb, gZc, gZd determined on the basis of the acquired second user input ZBb, ZBc, ZBd or the transmission of the parameter corresponding to the joint assignment, in each case to the selected plurality of devices 1a, 1d, 1f, 1h. in particular during execution, in particular by means of the system 10, the operation of the selected plurality of devices 1a, 1d, 1f, 1h, in each case using the transmitted joint assignment gZb, gZc, gZd or the transmitted parameter corresponding thereto, following the adoption of the assignment gZb, gZc, gZd or the parameter.

In detail, temporally after step a) and before step b), the method includes the step of: determining the executable joint assignment gZa, gZb, gZc, gZd on the basis of the acquired first user input VBa, VBd, VBf, VBh, in particular by means of at least one portion 2a of a buffer storage 2.

Moreover, the selected plurality of devices 1a, 1d, 1f, 1h each comprise at least one assignment Za, Zb, Zc, Zd executable for them. The executable joint assignment gZa, gZb, gZc, gZd is determined as an intersection Za, Zb, Zc, Zd of the at least one executable assignment Za, Zb, Zc, Zd.

Moreover, the devices 1a, 1b, 1c, 1d, 1e, 1f, 1g, 1h, 1i, 1j, 1k comprise different types of work equipment 1a, 1c, 1d, 1e, 1f, 1g, 1h, 1i, 1j. In particular, the piece of work equipment 1a, 1c, 1d, 1e, 1f, 1g, 1h, 1i, 1j is a piece of user-controlled work equipment 1c, 1e, 1g, 1i or an autonomous mobile work robot 1a, 1d, 1f, 1h, 1j.

In particular, the piece of work equipment 1a, 1c, 1d, 1e, 1f, 1g, 1h, li, 1j is a saw 1c, 1e, a chainsaw in particular, a pole pruner, a hedge trimmer, a hedge cutter, a wood cutter, pruning shears, a blower, a leaf blower, a suction device, a leaf vacuum, a cleaning device, a pressure washer, a spraying device, a sweeper, a sweeping roller, a sweeping brush, a lawnmower 1a, 1d, 1f, 1h, 1j, a robotic lawnmower in particular, grass shears, a scarifier, a brush cutter 1g, 1i, an angle grinder, a stone cutter or a combination tool made of a plurality of the aforementioned types of work equipment.

Furthermore, the executable joint assignment gZa, gZb, gZc, gZd comprises a modifiable setting gZb, gZc, gZd, EI, a modifiable grouping or a command gZa, BE, a modifiable command in particular. In particular, the second user input ZBb, ZBc, ZBd determines a modification VE or a confirmation BS of the setting EI, a modification, a creation or a confirmation of the grouping or an execution or a modification of the command BE.

In detail, temporally after step c) including the acquisition of the second user input ZBb, ZBc, ZBd determining the joint assignment gZb, gZc, gZd comprising the setting EI or the grouping and temporally before step d), the method includes the step of: acquiring a user input, exactly one user input in particular, for initiation AB. Step d) including the transmission of the determined joint assignment gZb, gZc, gZd comprising the setting EI or the grouping or the parameter corresponding thereto is executed initiated by the acquisition of the user input for initiation AB. In addition to that or in an alternative, step d) including the transmission of the determined joint assignment comprising the command or the parameter corresponding thereto is executed initiated by the acquisition of the second user input determining the joint assignment comprising the command.

Moreover, the method is such that the transmitted joint assignment gZb, gZc, gZd comprising the setting EI or the grouping or the transmitted parameter corresponding thereto is adopted by the device 1a, 1d, 1f, 1h in the event of a non-operation thereof, and in particular is not adopted during an operation of the device 1a, 1d, 1f, 1h.

In the exemplary embodiment shown, the devices 1a, 1d, 1f, 1h, the four devices in particular, in particular in the form of the four lawnmowers 1a, 1d, 1f, 1h, are selected by means of acquiring the user inputs VBa, VBd, VBf, VBh, four user inputs in particular, in particular in the form of clicking on respective “device” buttons.

Hence the executable joint assignments gZa, gZb, gZc, gZd, the four executable joint assignments in particular, are output.

In detail, the setting EI for the lawnmowers 1a, 1d, 1f, 1h, 1j is a cutting height, a mowing duration or a rain sensitivity of a rain sensor of the respective lawnmower 1a, 1d, 1f, 1h, 1j.

In addition to that or in an alternative, the command BE for the autonomous mobile work robot 1a, 1d, 1f, 1h, 1j is for starting. In alternative exemplary embodiments, the command may be for interrupting or pausing, for stopping or for returning home, in addition to the above or in an alternative.

In particular, in the exemplary embodiment shown for the robotic lawnmower 1a, 1d, 1f, 1h, 1j, the command BE is to start mowing. In particular, the second user input is in the form of clicking a “start mowing” button.

In alternative exemplary embodiments, the setting may be a fixed throttle setting for the user-controlled piece of work equipment.

In addition to that or in an alternative, the setting may be an “eco-mode” setting for the work equipment, in particular for the blower, the leaf blower, the suction device or the leaf vacuum.

In a further addition to that or in a further alternative, the setting may be an “energy saving” setting for the devices.

In a further addition to that or in a further alternative, the setting may be a charging setting for the rechargeable battery pack and/or the charger.

In a further addition to that or in a further alternative, the grouping for the devices may be a grouping into a “municipal park” group or team, a “botanical gardens” group, a “forestry” group or a “golf club” group.

In a further addition to that or in a further alternative, the command for the devices may be a command for identification and/or for finding, in particular for an optical and/or acoustic output, e.g. by means of an LED and/or a loudspeaker of the device. This allows identification and/or finding of the devices, for instance from the set of devices in a workshop and/or under hedge cuttings or leaves outdoors.

Should the rechargeable battery pack and the lawnmower in particular be selected, the setting “cutting height” is not output for both, instead it is the grouping and/or the command, in particular for identification, that is output.

In a further addition to that or in an alternative, the second user input ZBb, ZBc, ZBd or the user input for initiation AB is in the form of clicking a “save” button.

In other words: To determine the one joint assignment, the exactly one joint assignment in particular, for the selected plurality of devices together, the user requires the one second user input, the exactly one second user input in particular, or only a single action, e.g. clicking on the button, and in particular does not require a plurality of user inputs, in each case for the devices on an individual basis.

Moreover, temporally after step d), the method includes the step of: outputting information Info about a status ST regarding an adoption by the device 1a, 1d, 1f, 1h of the transmitted joint assignment gZb, gZc, gZd or of the transmitted parameter corresponding thereto, in particular wherein the status ST is adoption executed STa, adoption failed STb or adoption pending STc.

Moreover, the acquisition of the first user input VBa, VBd, VBf, VBh, of the second user input ZBb, ZBc, ZBd and/or of the user input for initiation AB comprises a haptic acquisition and/or is executed by means of a terminal 3, a mobile terminal in particular. In addition to that or in an alternative, the output of the possible joint assignment gZa, gZb, gZc, gZd and/or of the information Info comprises an optical output and/or is executed by means of the terminal 3.

Furthermore, step d) includes: transmitting the determined joint assignment gZb, gZc, gZd or the parameter corresponding thereto from the terminal 3 to the buffer storage 2. transmitting the determined joint assignment gZb, gZc, gZd, the parameter corresponding thereto or a parameter corresponding thereto from the buffer storage 2 to the selected plurality of devices 1a, 1d, 1f, 1h.

In detail, the buffer storage 2 comprises the terminal portion 2a and a device portion 2b. A communication of the determined joint assignment gZb, gZc, gZd or the parameter corresponding thereto from the terminal 3 to the terminal portion 2a comprises a synchronous communication. A communication of the determined joint assignment gZb, gZc, gZd, the parameter corresponding thereto or the parameter corresponding thereto from the terminal portion 2a to the device portion 2b for the transmission to the selected plurality of devices 1a, 1d, 1f, 1h comprises an asynchronous communication.

Otherwise, the device portion 2b is divided into two or comprises the right portion and additionally a left portion or a data provision device in FIG. 1, and/or the system 10 comprises the data provision device, in particular between the device portion 2b, the right device portion in particular, and the devices 1a, 1d, 1f, 1h, the selected plurality of devices in particular.

In addition to that or in an alternative, a plurality of device backends and further interfaces for cloud-to-cloud communication have not been depicted here, e.g. a weather service, support services, databases, etc.

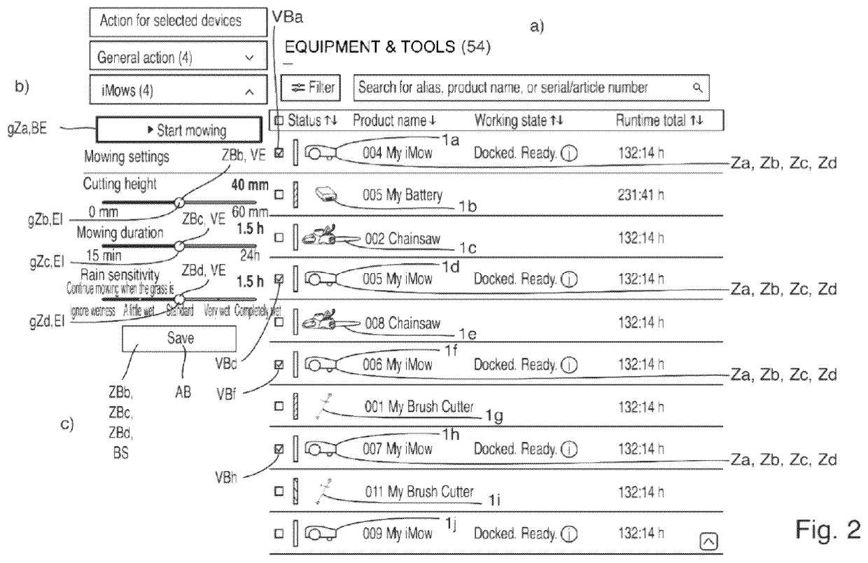

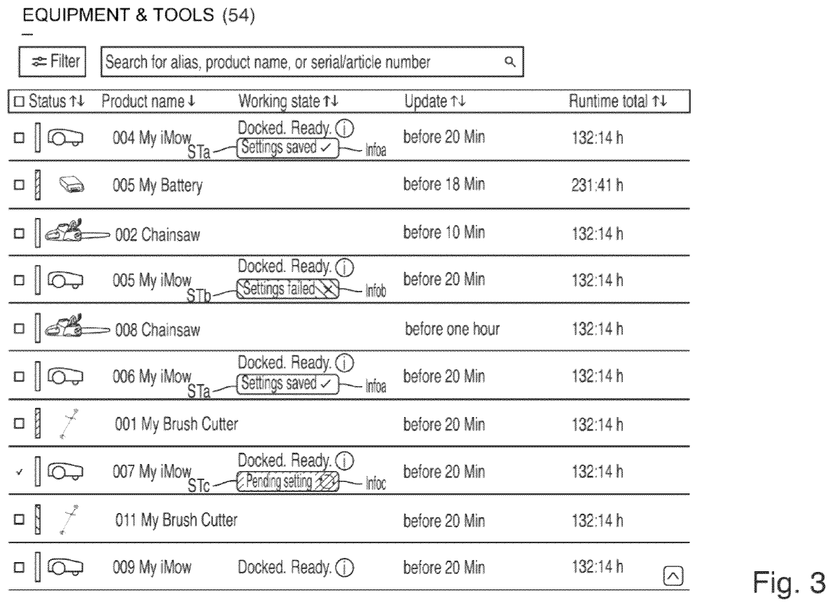

In other words: for control purposes, the user uses a user interface, as shown in FIGS. 2 and 3, for example in the form of a web app, which is provided via the terminal 3 or an app frontend, as shown in FIG. 1. The user interface allows simultaneous monitoring of status and availability of the devices by displaying a list of devices. For control purposes, the steps mentioned above are provided, some of which are mentioned again below:
The user chooses the devices, for which the assignment(s) should be executed or adopted, via the user interface.
Based on or on the basis of the selection of the user, the user interface shows the jointly executable assignment(s) for the selected devices.

As the shown exemplary embodiments, which were explained above, make clear, the invention provides an advantageous method, an advantageous system and an advantageous computer program product for joint control of a plurality of devices, the method, system and/or computer program product having improved properties.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for joint control of a plurality of devices (1a, 1d, 1f, 1h) selected from a set comprising at least one piece of work equipment (1a, 1c, 1d, 1e, 1f, 1g, 1h, 1i, 1j), at least one rechargeable battery pack (1b) for the piece of work equipment (1c, 1e, 1g, 1i) or at least one charger (1k) for the rechargeable battery pack (1b), the method comprising the steps of:
a) acquiring at least one first user input (VBa, VBd, VBf, VBh) selecting the plurality of devices (1a, 1d, 1f, 1h) from the set;
b) outputting at least one executable joint assignment (gZa, gZb, gZc, gZd) determined on the basis of the acquired at least one first user input (VBa, VBd, VBf, VBh) so as to be jointly executable for the selected plurality of devices (1a, 1d, 1f, 1h);
c) acquiring a second user input (ZBb, ZBc, ZBd) determining at least one joint assignment (gZb, gZc, gZd) from the output of the at least one executable joint assignment (gZa, gZb, gZc, gZd); and
d) transmitting the joint assignment (gZb, gZc, gZd) determined on the basis of the acquired second user input (ZBb, ZBc, ZBd) or transmitting a parameter corresponding to the joint assignment, in each case to the selected plurality of devices (1a, 1d, 1f, 1h).

2. The method according to claim 1, wherein
the acquiring of the second user input acquires exactly one second user input, and
the determining of the at least one joint assignment determines exactly one joint assignment.

3. The method according to claim 1, wherein, temporally after step a) and before step b), the method comprises the step of:
determining the executable joint assignment (gZa, gZb, gZc, gZd) on the basis of the acquired first user input (VBa, VBd, VBf, VBh).

4. The method according to claim 3, wherein the determining of the executable joint assignment is by way of at least one portion of a buffer storage.

5. The method according to claim 1,
wherein the selected plurality of devices (1a, 1d, 1f, 1h) each comprise at least one assignment (Za, Zb, Zc, Zd) executable for them, and
wherein the executable joint assignment (gZa, gZb, gZc, gZd) is determined as an intersection (Za, Zb, Zc, Zd) of the at least one executable assignment (Za, Zb, Zc, Zd).

6. The method according to claim 1,
wherein the set comprises different types of work equipment (1a, 1c, 1d, 1e, 1f, 1g, 1h, 1i, 1j), and
wherein the piece of work equipment (1a, 1c, 1d, 1e, 1f, 1g, 1h, 1i, 1j) is a piece of user-controlled work equipment (1c, 1e, 1g, 1i) or an autonomous mobile work robot (1a, 1d, 1f, 1h, 1j).

7. The method according to claim 1,
wherein the executable joint assignment (gZa, gZb, gZc, gZd) comprises a modifiable setting (gZb, gZc, gZd, EI), a modifiable grouping or a command (gZa, BE), and
wherein the second user input (ZBb, ZBc, ZBd) determines a modification (VE) or a confirmation (BS) of the setting (EI), a modification, a creation or a confirmation of the grouping, or an execution or a modification of the command (BE).

8. The method according to claim 7, wherein, temporally after step c) including the acquisition of the second user input (ZBb, ZBc, ZBd) determining the joint assignment (gZb, gZc, gZd) comprising the setting (EI) or the grouping and temporally before step d), the method comprises the step of:
acquiring a user input for initiation (AB), and wherein step d) including the transmission of the determined joint assignment (gZb, gZc, gZd) comprising the setting (EI) or the grouping or the parameter corresponding thereto is executed initiated by the acquisition of the user input for initiation (AB), and/or
wherein step d) including the transmission of the determined joint assignment comprising the command or the parameter corresponding thereto is executed initiated by the acquisition of the second user input determining the joint assignment comprising the command.

9. The method according to claim 7, wherein
the transmitted joint assignment (gZb, gZc, gZd) comprising the setting (EI) or the grouping or the transmitted parameter corresponding thereto is adopted by the device (1a, 1d, 1f, 1h) in an event of a non-operation thereof, and is not adopted during an operation of the device (1a, 1d, 1f, 1h).

10. The method according to claim 1, wherein, temporally after step d), the method comprises the step of:
outputting information (Info) about a status (ST) regarding an adoption by the device (1a, 1d, 1f, 1h) of the transmitted joint assignment (gZb, gZc, gZd) or of the transmitted parameter corresponding thereto.

11. The method according to claim 10, wherein the status (ST) is adoption executed (STa), adoption failed (STb) or adoption pending (STc).

12. The method according to claim 1,
wherein the acquisition of the first user input (VBa, VBd, VBf, VBh), of the second user input (ZBb, ZBc, ZBd) and/or of the user input for initiation (AB) comprises a haptic acquisition and/or is executed via a terminal, and/or
wherein the output of the possible joint assignment (gZa, gZb, gZc, gZd) and/or of the information (Info) comprises an optical output and/or is executed via the terminal.

13. The method according to claim 12, wherein the terminal is a mobile terminal.

14. The method according to claim 1, wherein step d) comprises:
transmitting the determined joint assignment (gZb, gZc, gZd) or the parameter corresponding thereto from a terminal to a buffer storage, and
transmitting the determined joint assignment (gZb, gZc, gZd), the parameter corresponding thereto or a parameter corresponding thereto from the buffer storage to the selected plurality of devices (1a, 1d, 1f, 1h).

15. The method according to claim 14,
wherein the buffer storage comprises a terminal portion and a device portion,
wherein a communication of the determined joint assignment (gZb, gZc, gZd) or the parameter corresponding thereto from the terminal to the terminal portion comprises a synchronous communication, and
wherein a communication of the determined joint assignment (gZb, gZc, gZd), the parameter corresponding thereto or a parameter corresponding thereto from the terminal portion to the device portion for the transmission to the selected plurality of devices (1a, 1d, 1f, 1h) comprises an asynchronous communication.

16. The method according to claim 1, wherein, temporally after step d), the method comprises the step of:
operating the selected plurality of devices (1a, 1d, 1f, 1h) in each case using the transmitted joint assignment (gZb, gZc, gZd) or the transmitted parameter corresponding thereto following adoption of the assignment (gZb, gZc, gZd) or the parameter.

17. A system for joint control of a plurality of devices (1a, 1d, 1f, 1h) selected from a set comprising at least one piece of work equipment (1a, 1c, 1d, 1e, 1f, 1g, 1h, 1i, 1j), at least one rechargeable battery pack (1b) for the piece of work equipment (1c, 1e, 1g, 1i) or at least one charger (1k) for the rechargeable battery pack (1b), the system comprising:
the plurality of devices;
an acquisition apparatus, an output apparatus and a transmission apparatus;
wherein the acquisition apparatus is configured to acquire at least one first user input (VBa, VBd, VBf, VBh) selecting the plurality of devices (1a, 1d, 1f, 1h) from the set,
wherein the output apparatus is configured to output at least one executable joint assignment (gZa, gZb, gZc, gZd) determined on the basis of the acquired at least one first user input (VBa, VBd, VBf, VBh) so as to be jointly executable for the selected plurality of devices (1a, 1d, 1f, 1h),
wherein the acquisition apparatus is configured to acquire a second user input (ZBb, ZBc, ZBd) determining at least one joint assignment (gZb, gZc, gZd) from the output of the at least one executable joint assignment (gZa, gZb, gZc, gZd), and
wherein the transmission apparatus is configured to transmit the joint assignment (gZb, gZc, gZd) determined on the basis of the acquired second user input (ZBb, ZBc, ZBd) or transmit a parameter corresponding to the joint assignment, in each case to the selected plurality of devices (1a, 1d, lf, 1h).

18. The system according to claim 17, wherein the system is configured to operate the selected plurality of devices (1a, 1d, 1f, 1h), in each case using the transmitted joint assignment (gZb, gZc, gZd) or the transmitted parameter corresponding thereto, following the adoption of the assignment (gZb, gZc, gZd) or the parameter.

19. A computer product comprising a non-transitory computer-readable medium having stored thereon commands for joint control of a plurality of devices (1a, 1d, 1f, 1h) selected from a set comprising at least one piece of work equipment (1a, 1c, 1d, 1e, 1f, 1g, 1h, 1i, 1j), at least one rechargeable battery pack (1b) for the piece of work equipment (1c, 1e, 1g, 1i) or at least one charger (1k) for the rechargeable battery pack (1b), wherein the commands, when executed, cause the acts of:
a) acquiring at least one first user input (VBa, VBd, VBf, VBh) selecting the plurality of devices (1a, 1d, 1f, 1h) from the set;
b) outputting at least one executable joint assignment (gZa, gZb, gZc, gZd) determined on the basis of the acquired at least one first user input (VBa, VBd, VBf, VBh) so as to be jointly executable for the selected plurality of devices (1a, 1d, 1f, 1h);
c) acquiring a second user input (ZBb, ZBc, ZBd) determining at least one joint assignment (gZb, gZc, gZd) from the output of the at least one executable joint assignment (gZa, gZb, gZc, gZd); and
d) transmitting the joint assignment (gZb, gZc, gZd) determined on the basis of the acquired second user input (ZBb, ZBc, ZBd) or transmitting a parameter corresponding to the joint assignment, in each case to the selected plurality of devices (1a, 1d, 1f, 1h).
